(19) United States
(12) Patent Application Publication
(10) Pub. No.: US 2007/0196930 A1
(43) Pub. Date: Aug. 23, 2007

(54) Molecular stamp for printing biomolecules onto a substate

(75) Inventors: Ties Van Bommel, Eindhoven (NL); Rifat Ata Mustafa Hikmet, Eindhoven (NL); Hendrik Roelof Stapert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,415

(22) PCT Filed: Nov. 24, 2004
(86) PCT No.: PCT/IB04/52528

§ 371 Date: Jun. 13, 2006

(30) Foreign Application Priority Data
Dec. 16, 2003 (EP) 03104724.4

(51) Int. Cl. B01L 3/02

(52) U.S. Cl. 436/180; 422/100

(57) ABSTRACT

The invention pertains to a molecular stamp for printing biomolecules onto a substrate comprising a hydrophylic polymeric gel and a patterned surface, characterized in that the gel has at least 20% crosslink density. Preferably, the stamp comprises a gel which is obtainable by polymerizing at least one of a water soluble ethylenically unsaturated and/or epoxidated monomer containing at least one functional group selected from a hydroxyl, alkoxyl, amine, alkyl substituted amine, carboxylic acid, carboxylic ester, carboxylic anhydride, carboxamide, isocyanate, carbamate, urethane, and urea group, in the presence of a polymerization initiator and optionally a chain transfer agent, and crosslinking the polymer with a crosslinker having at least two ethylenically unsaturated groups and/or epoxy groups.

The invention pertains to a molecular stamp for printing biomolecules onto a substrate, to a method for making said stamps, and to a method of printing biomolecules onto the substrate.

In molecular diagnostics use is made of arrays, also called biochips. Arrays are substrates that contain a high number of probes on a relatively small area, currently in the order of 1×3 inch×inch, which is the size of a microscope plate that is often used in array-based genomics and proteomics. Gene probes can be placed on the substrate using lithographic techniques or inkjet printing techniques. These production techniques as well as the biological samples are expensive. Protein probes (protein arrays) are usually placed using spotting robots. Circular spots can be formed with a typical diameter of about 150 μm. A miimum spot diameter of about 60 μm was reported so far. Lithographic techniques such as used in the production of DNA arrays cannot be used for protein arrays.

Diagnostic cartridges will, apart from a detection part also contain channels for transportation of fluids and most likely also separation, mixing and filtering modules/chambers. These cartridges are in total also of about the same size as the bio-arrays currently available. Because diagnostic cartridges require a much higher level of integration, the detection part will be much smaller than the total cartridge. The area where the probes should be placed is often typically below 1×1 cm², which is much smaller than a microscope slide.

Moreover, miniaturization of the detection part is also driven by cost reduction. First, because the detection part of the cartridge may well be made in silicon the size of this part should be as small as possible. Second, the bioprobes are highly expensive molecules and the quantities used should be minimized as much as possible. Multi-analyte detection protocols for molecular diagnostics will need the ability of measuring 10-1000 biological compounds (DNA/RNA, proteins, sugars, metabolites, cells) on a single cartridge. Thus, there is a strong need for cheap production methods that can place many (and different) biological recognition probes on small-scale substrates. Additionally, these methods should also include the possibility of placing different shapes (rectangular, squares) and not only circles, which is the only possibility on flat substrates with the currently available pin-spotting robots. Finally, the method should be such that the biological function of the bio-probes should remain intact. For example, when antibodies are immobilized their affinity constant (K_{d}) should remain as high as possible.

In U.S. Pat. No. 5,948,621 an attempt was made to solve these problems. A molecular stamp was reported comprising a solid support and a polymeric gel covalently bond to said support to form a patterned surface. The gel must be irreversibly bond to a support and the gel contains pores to absorb the biomaterial to be stamped. The materials used for these gels are acrylic acids esterified to a sugar. The gel is about 0.5 to 10%, most preferably 2 to 4% crosslinked. Higher crosslink densities could not be used because of increased fragility of the hydrogel, and decrease of elasticity and stability of handling. Further, in fact only the 2-4% crosslinked gels provide consistently large and homogeneous pores, and the 2% crosslinked gel is the better choice to form the capillary hydrogel. The water content of such gels after preparation was typically 85%. Upon hydrating the water content increased to 90% and 97.3% for the 4% and 2% crosslinked gels, respectively. Finally, the images have a spatial resolution of about 10 micrometers edge distance. Although these above-mentioned stamps have many advantages and overcome many of the prior art disadvantages, there is still a need for further improvement.

It is therefore an objective of the present invention to provide a molecular stamp that is devoid of the disadvantages of the prior art stamps, i.e. to provide a molecular stamp that is not necessarily bonded to a substrate and that can be used as a self supporting stamp, that allows adsorption and absorption of the biomaterial rather than absorption into pores, and wherein the spatial resolution is further improved, under maintaining the robustness, the elasticity, and the stability of handling.

To this end the invention relates to a molecular stamp for printing biomolecules onto a substrate comprising a hydrophylic polymeric gel and a patterned surface, characterized in that the gel has at least 20% crosslink density.

The high crosslink density is important to obtain a stamp that is self-supporting, i.e. does not need a support and can be used as such. It is therefore preferred to increase the crosslinking to at least 30%, more preferably at least 40%. More preferably, the stamp comprises a polymer concentration of at least 50%.

Other molecular stamps are also described, for instance in U.S. Pat. No. 6,444,254. The method described therein refers to a reactive microstamping technique that enables biological ligands and proteins to be directly patterned on polymer is substrates. A polymer surface with reactive moieties is contacted with a stamp. On the surface of the stamp a ligand is absorbed comprising another reactive moiety to form a covalent bond with the first reactive moiety on the polymer. Although hardly any restrictions exist to the stamp, which is not patterned and only must be able to absorb the biomaterial, according to this method only specifically functionalized substrates can be used, and only ligands that contain a functionalized group to form a covalent bond with the functionalized substrate. It goes without saying that such method has only limited application.

The use of microcontact printing technique with PDMS stamps for protein arrays has also been suggested (see e.g. Bernard, A, Delamarche, E., Schmid, H., Michel, B., Bosshard, H. R., Biebuyck, H., Langmuir. 14, 9, 2225-2229, 1998, and Bernard, A, Renault, J. P. Michel, B., Bosshard, H. R., Delamarche, E., Advanced Materials, 12, 14, 1067-1070, 2000). However it is well known that PDMS is a very hydrophobic material and surface modification needs to be used which does not lead to reproducible stamps.

The gel stamps of the invention can be used in printing biological molecules from aqueous solutions. With these gel stamps the molecules can stay in the wet state after printing, which is very important in order to preserve their biological activity. Printing can be performed by hand or by machine, such as a waveprinter.

The gels can be synthesized by using hydrophilic molecules with one or more reactive groups, comprising the steps:
polymerizing at least one of a water soluble ethylenically unsaturated and/or epoxidated monomer containing at least one functional group selected from a hydroxy, alkoxy, amine, alkyl substituted amine, carboxylate, carboxylic ester, carboxamide, anhydride, urethane, and urea group, in the presence of a polymerization initiator and optionally a chain transfer agent, and
   crosslinking the polymer with a crosslinker having at least two ethylenically unsaturated groups and/or epoxy groups to a crosslinked polymer with a crosslink density of at least 20%.

The gel can be produced either by first including water and optionally biomolecules in the mixture. Subsequently the mixture can be used to replicate pre-fabricated surface structures by in situ polymerization. The advantage of this method is that the polymer does not further swell when it is dipped in a solution with biomolecules, thereby maintaining the dimensions of the replicated structure the same. Dipping is necessary each time before printing.

Examples of particularly suitable monomers to be used in the polymerization are:

(Meth)acrylates:
CH₂═CR—CO—O—Y-E

Vinyl ethers:
CH₂═CH—O—Y-E

Epoxides:

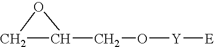

Dithiols which give polymers with e.g divinyls upon a Michael addition, in the presence of a strong base, can also be used:
HS—Y—HS CH₂═CH—Y—CH═CH₂
wherein R is H, CH₃, CH₂CH₃, or halogen, preferably Cl, and

Y=((CRR′)ₘ)ₙ or ((CRR′)ₘZ)ₙ, with Z=O, N, C(O), C(O)O, C(O)N(H), N(H)C(O)O, OC(O)O and R,R′ are H, CH₃, C2-8 alkyl, halogen; and n=1-25; m=1-8

E is hydrogen, methyl, hydroxyl, alkoxyl, amine, alkyl substituted amine, carboxylic acid and salts thereof, such as COOR′, with R′=H, Na, K, Li, NR₃″ wherein R″ is alkyl, carboxylic ester, carboxylic anhydride, carboxamide, isocyanate, or a urea group

Examples of Y-E are alcohols such as —(CH₂)ₙOH, and acids.

Other groups for E are also possible such as sulfonates, such as O—SO₃R′R′ has the previously given meanings.

Examples of crosslinkers are 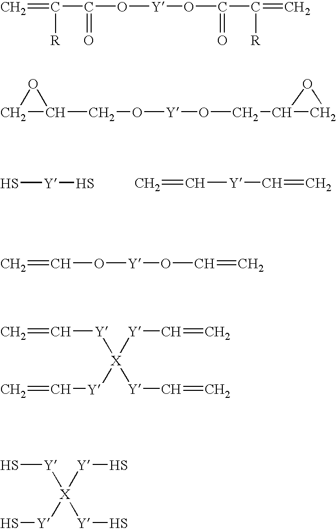
wherein R has the previously given meaning and Y′ has the same meaning as Y or is an analogue thereof, or can be a short apolar group such as alkyl or phenyl. X is a small molecule binding the arms together such as a carbon atom or a benzene ring. Chain-transfer agents can optionally be added and are for instance HS—Y—R, wherein Y and R have the previously given meanings.

The polymerization reaction can be performed in an aqueous buffer solution, such as PBS (phosphate buffered saline), Tris, TE, Hepes buffers The polymerization reaction is performed in the presence of a polymerization initiator, such as Darocure® 1173. The initiator can be thermal initiator or, preferably, a photo-initiator.

The invention is illustrated by FIGS. A-G and by the example.

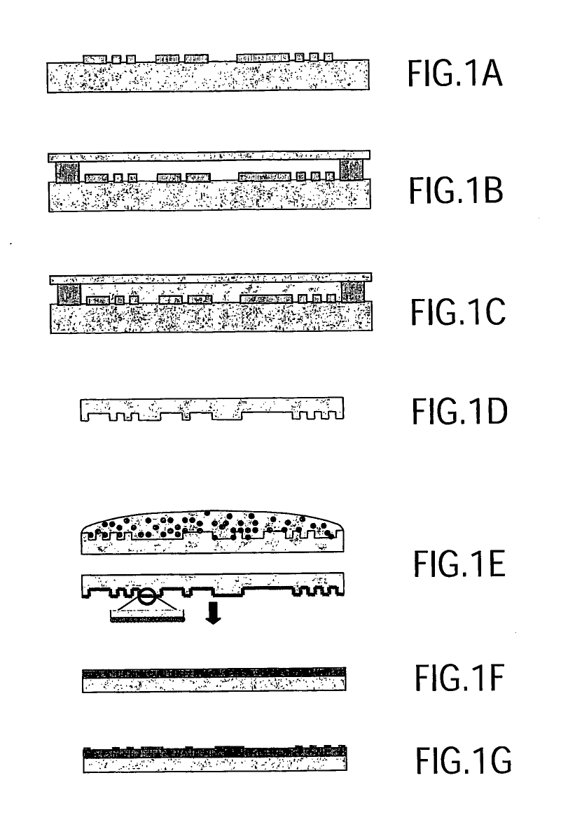

In FIGS. 1A-G a schematic representation is given of a procedure for directly patterning proteins on a substrate.

FIG. 1A shows a master with the inverse structure of the desired stamp. FIG. 1B shows applying spacers and cover glass to the master. In FIG. 1C the liquid mixture comprising the functionalized monomers, crosslinker, crosslinking agent, buffer, photo-initiator, and optionally chain-transfer agent and/or biomolecules are applied and the mixture is exposed to UV light to form a polymer. In FIG. 1D the patterned gel is peeled off from the master, giving a stamp which is patterned by protrusions. In FIG. 1E the stamp is loaded with a buffered solution of proteins. Loading may also be performed before contacting the stamp with the biomaterial. Because the polymerization is in most instances performed in an aqueous medium, swelling occurs simultaneously with the formation of the polymer. In FIG. IF the stamp is rinsed with buffer and/or dried under a stream of nitrogen and the biomaterial is stamped on a substrate. In FIG. 1G a substrate with a structure on top is showed. Biomolecules are adsorbed to and/or in the gel structures.

### EXAMPLE

A highly hydrophilic stamp was made suitable for printing biomolecules on flat (gold) substrates with very low spatial resolution (rectangles with 1 μm width). The stamps can be tuned such that the water content (swelling, size) can be controlled. A highly hydrophilic stamp was necessary to print biomolecules that retain their biological function. These stamps could also used to print many other biological samples.

Materials and Methods

Preparation of Gold Substrates:

Gold substrates were prepared by evaporating 5 nm of Ti, followed by 25 nm of Au, onto a silicon substrate. Subsequently, the substrates were thoroughly rinsed with distilled, de-ionized water, ethanol, and heptane. The substrates were cleaned by exposure to argon plasma for 5 minutes.

Preparation of Chemicals:

The mixture for producing the stamps contains 40 wt. % of hydroxyethyl acrylate (MW 116.1, ex Polysciences), 10 wt. % of polyethylene glycol (400) diacrylate (ex Kayarad), 50 wt. % of water and 0.5 wt. % of photoinitiator Darocure® 1173 (ex Merck), giving a gel where the polymer contains 20% cross-links.

Another mixture has the following composition: 72 wt. % of hydroxyethyl acrylate, 18 wt. % of polyethylene glycol (400) diacrylate, 10 wt. % of water, and 0.5 wt. % od Darocure® 1173. This again gives a gel where the polymer contains 20% cross-links.

A 1 mg/ml solution of labeled protein, BSA-FITC (albumin, fluorescein isothiocyanate conjugate bovine), obtained from Sigma, in 0.01M of PBS buffer was used (pH≈7.3) as a model protein.

Micro Contact Printing of Proteins:

By applying spacers and a cover glass onto a master a stamp was produced (see FIG. 1A,B). This mold was completely filled with the above-described liquid mixture (see FIG. 1C). A stamp was obtained after UV-exposure of the polymeric mixture in the mold (e.g. 1 minute at 4 mW/cm², see FIG. 1D). Subsequently, the stamp was immersed in a solution of protein in aqueous buffer for a certain time (e.g. 1 minute at 20-25° C.) (see FIG. 1E). After immersing, the stamp was rinsed with distilled, de-ionized water and/or dried with a stream of nitrogen. The stamp was then contacted with the clean gold surface for about 1 minute (see FIG. 1G).

Detection of Printed Structures:

Fluorescence images were acquired with a DMLM Leica® Fluorescence Microscope including a Photometric Coolsnap® HQ CCD camera, an ultra-high pressure mercury lamp and a Leica® filter cube L5. Image-Pro® Plus 4.5 software was used for data analysis.

1. A molecular stamp for printing biomolecules onto a substrate comprising a hydrophylic polymeric gel and a patterned surface, characterized in that the gel has at least 20% crosslink density.

2. The molecular stamp of claim 1 wherein the gel is obtainable by polymerizing at least one of a water soluble ethylenically unsaturated and/or epoxidated monomer containing at least one functional group selected from a hydroxy, alkoxy, amine, alkyl substituted amine, carboxylate, carboxylic ester, carboxylic anhydride, carboxamide, carbamate, urethane, and urea group, in the presence of a polymerization initiator and optionally a chain transfer agent, and crosslinking the polymer with a crosslinker having at least two ethylenically unsaturated groups and/or epoxy groups.

3. The molecular stamp of claim 1 wherein the monomer is a hydroxyalkyl(meth)acrylate and the crosslinker is a polyethyleneglycol di(meth)acrylate.

4. The molecular stamp of claim 1 wherein the stamp is self-supporting.

5. The molecular stamp of claim 1 wherein the crosslink density is at least 40%.

6. The molecular stamp of claim 1 wherein the polymer concentration is at least 50%.

7. A method for preparing the stamp of claim 1:
polymerizing at least one of a water soluble ethylenically unsaturated and/or epoxidated monomer containing at least one functional group selected from a hydroxy, alkoxy, amine, alkyl substituted amine, carboxylate, carboxylic ester, carboxamide, anhydride, urethane, and urea group, in the presence of a polymerization initiator and optionally a chain transfer agent, and
crosslinking the polymer with a crosslinker having at least two ethylenically unsaturated groups and/or epoxy groups to a crosslinked polymer with a crosslink density of at least 20%.

8. A method of printing biomolecules onto a substrate, preferably a gold substrate, comprising the steps:
optionally swelling the stamp of any one of claims 1-6 with water or buffer
loading a biomolecule onto the surface of the stamp by contacting the patterned surface of the stamp with the biomolecule,
optionally rinsing the surface with water or a buffer and/or drying the stamp, and
bringing the surface of the stamp with the adsorbed biomolecule into contact with a substrate followed by transferring the biomolecule from the stamp to the substrate.
